(19) United States
(12) Patent Application Publication
(10) Pub. No.: US 2026/0251607 A1
(43) Pub. Date: Aug. 27, 2026

(54) ELECTROCHEMICAL SENSING ELECTRODES AND BIOSENSORS AND PRODUCTION METHODS

(71) Applicant: Roche Diabetes Care, Inc., Indianapolis, IN (US)

(72) Inventor: Kirill Sliozberg, Mannheim (DE)

(73) Assignee: Roche Diabetes Care, Inc., Indianapolis, IN (US)

(21) Appl. No.: 19/648,369

(22) Filed: Apr. 15, 2026

Related U.S. Application Data
(63) Continuation of application No. PCT/US2023/036796, filed on Nov. 3, 2023.

(51) Int. Cl. G01N 27/30; B23K 26/38; G01N 27/327; G01N 27/333; B23K 101/38

(52) U.S. Cl. CPC G01N 27/307; B23K 26/38; G01N 27/327; G01N 27/333; B23K 2101/38

(57) ABSTRACT

Disclosed are methods for producing a sensing electrode in which an area of electrode material is applied to a substrate, a sensing chemistry material is applied to cover the electrode material, and a laser is used to form a laser cut the sensing chemistry material and the electrode material in a pattern to define at least a portion of the perimeter of the sensing electrode. The laser cut forms a gap physically and electrically separating the sensing chemistry material and the electrode material inside the laser cut from the extraneous sensing chemistry material and the electrode material outside the laser cut. The methods further provide for producing a plurality of sensing electrodes which are separated from a continuous substrate. Further disclosed are the sensing electrodes produced by such methods.

### CROSS-REFERENCE TO RELATED APPLICATION

This application is the Continuation of International Application No. PCT/US2023/036796 filed November 3, 2023, the entire disclosure of which is hereby incorporated by reference.

### FIELD OF THE INVENTION

This invention relates to the field of biosensors for the electrochemical determination of analytes in a fluid.

### BACKGROUND OF THE INVENTION

Both in vivo and in vitro biosensors are commonly used to detect analytes in fluids. Electrochemical biosensors generally include at least a pair of electrodes carried by a substrate. A sensing chemistry specific to the analyte is applied over one or both of the electrodes, particularly the “working” electrode. In addition to the sensing chemistry, a diffusion limiting membrane is applied on top for diffusion-controlled operation mode. For these biosensors to be useful, they must have uniformity in order to operate based on associated calibrations. One of the pre-requisites for factory calibration of an analyte biosensor is that there is a well-defined active area of the sensing electrode with homogeneous coating of the sensing chemistry. Furthermore, a homogenous layer of the diffusion-limiting membrane is of utmost importance.

It has been known to use a laser to define the area of an electrode, thereby limiting the presence of some non-active areas. However, there has been a continuing problem in the art that non-uniformity of the sensing chemistry, and distortion of an overlying diffusion limiting membrane, have presented sources of inaccuracies in using the sensing electrodes.

### Non-Homogenous Chemistry

One source of the sensitivity scattering from sensor to sensor and sensitivity drift of single sensors is physical non-uniformity of the functional layers (sensing chemistry, diffusion-limiting membrane). The sensing chemistry is typically applied to the substrate as a wet reagent (i.e., a solution). As a result, the outer edges of the reagent may be not uniform. In particular, an “edge effect” can distort the shape of the sensing chemistry layer as it dries/cures. The outer edges of the sensing chemistry may be misshaped, and sensing chemistry coatings in the prior art have often had significantly large thickness inhomogeneity.

Referring to FIG. 1, there is shown a cross section of a sensing electrode of the prior art demonstrating the distortion of a sensing chemistry on a substrate. Sensing chemistry 10 covers conductive electrode material 11 located on substrate 12. The sensing chemistry has a relatively flat interior section 14. However, the portions 16 and 18 of the sensing chemistry 10 at the outer edges have an irregular surface profile due to the drying effect. These uneven edge areas of sensing chemistry 10 can distort the analyte measurement.

In the prior art, the solution has often been to remove large areas of sensing chemistry by means of surface laser ablation. However, if there is any remaining active chemistry in the area being ablated, it will continue to react with the analyte. This can result in a contribution to the current generation during a test due to analyte conversion by this extraneous sensing chemistry. In the past, the use of surface area ablation has therefore required that the laser be very intense in order to achieve complete removal of the sensing chemistry from these areas which are not supposed to be active towards the analyte. This adds to expense and slows the process of producing the sensing electrodes.

### Non-Homogeneous Diffusion Limiting Membrane

Another source of inhomogeneity in prior art sensors involves the diffusion limiting membrane. Electrochemical biosensors, particularly in vivo biosensors, are frequently covered with a diffusion limiting membrane to control the relative diffusion of the target analyte as compared to other reactive components. If the active area of the sensing electrode is non-homogeneously coated by the diffusion limiting membrane, it can lead to a diminished performance of the resulting sensing electrode.

FIG. 2 shows a sensing electrode 20 of the prior art having a substrate 22 carrying a carbon undercoating (electrode) 24 and an overlying sensing chemistry 26, which together extend fully to the edge 28 of electrode 20. A diffusion limiting membrane 30 is usually applied by dip-coating and, thus, surrounds the whole sensor. It is, thus, also positioned immediately above the sensing chemistry 26. At the edge 28 of the sensing electrode, it is shown that there is a redistribution of the diffusion limiting membrane due to surface tension. In this configuration, it is shown that the diffusion limiting membrane 30 is comparatively thin at the edge 28 of the sensing electrode. The arrows 32 schematically depict diffusion of analyte with the intensity thereof being represented by arrow thickness. The enhanced diffusion of the analyte at the edge stresses the sensing chemistry 26 more there, leading to its accelerated degradation. As a result, the sensitivity drift occurs over time.

One approach in the prior art for resolving this issue of a thinned diffusion limiting membrane has been the use of broad field laser ablation of the sensing chemistry. FIG. 3 shows the sensing electrode 20 with an outer portion 34 where the sensing chemistry layer 26 has been removed by broad field laser ablation. Since there is no sensing chemistry at the edge of the biosensor, diffusion at the edge is of reduced consequence as it is relatively distant from the sensing chemistry.

However, because of the elevated laser power used in ablating large amounts of the sensing chemistry 26, the carbon undercoating 24 is also partially ablated. The ablation of the outer portion 34 of the sensing chemistry 26 results in ablation of a portion of the underlying carbon 24. FIG. 3 provides a schematic representation of the resulting step profile 36 and the inhomogeneous layer thickness of the diffusion limiting membrane. The thickness of the removed carbon coating may reach 10 µm and more. The thinned membrane at the step allows for disproportionately large diffusion, as represented by arrows 38 at the sensor edge.

### SUMMARY OF THE INVENTION

Disclosed herein are methods for the production of electrochemical analyte sensing electrodes and biosensors. Also disclosed are novel sensing electrodes, and biosensors employing the sensing electrodes. The sensing electrodes and biosensors address problems with prior art biosensors resulting from inhomogeneity of electrodes, sensing chemistries, and diffusion limiting membranes. By comparison to the prior art, the disclosed sensing electrodes have enhanced uniformity and homogeneity. Furthermore, the reduction of the inactive surface area drastically improves sensor performance in terms of immunity towards interfering substances.

In one aspect, there are disclosed methods for producing sensing electrodes comprising a substrate supporting a layer of electrode material covered with sensing chemistry material. The method comprises applying a layer of electrode material onto the substrate, and applying a sensing chemistry material over the electrode material. Following the application of the sensing chemistry, a laser cut is made fully through the electrode material and the sensing chemistry material in a configuration to at least partially define the sensing electrode inside of the laser cut. The laser cut forms a gap in both the electrode material and the sensing chemistry material, which physically and electrically separates the sensing electrode inside the gap from the electrode material and the sensing chemistry material outside the gap. The laser-formed gap thereby defines a uniform, active surface area of the sensing electrode. The formed sensing electrode is isolated from electrode material and sensing chemistry material that is on the substrate but outside the generated perimeter.

In another aspect, there are disclosed sensing electrodes and biosensors such as produced by the disclosed methods. In an aspect, the present invention provides an electrochemical analyte sensing electrode comprising a substrate having a first surface. An area of electrode material is located on the first surface, and the area of electrode material is covered by sensing chemistry material. The electrode material and the sensing chemistry material comprise a gap which extends into and through the electrode and sensing chemistry materials all the way to the substrate. This gap therefore physically and electrically separates the electrode material and the sensing chemistry material inside the gap from the electrode material and the sensing chemistry material outside the gap. The electrode material and the sensing chemistry material inside the gap comprise a sensing electrode isolated from the electrode material and the sensing chemistry material on the substrate outside the gap.

It is an object of the present invention to provide sensing electrodes and biosensors which benefit from having improved sensing electrode components. The sensing electrodes have electrode components which have more refined edges, and therefore more precise and more uniform edges, than in the prior art. The sensing chemistry and diffusion limiting membrane also are more uniform and more homogeneous. The latter gets its uniformity due to filling the gap during the membrane application, forming, thus forming no thinned areas.

In a first embodiment, disclosed is a method for producing a sensing electrode comprising: applying an area of electrode material onto a first surface of a substrate; applying a sensing chemistry material covering the area of electrode material; and following the applying of the sensing chemistry material, directing a laser beam toward the substrate to form a laser cut in a pattern configured to define at least a portion of the perimeter of the sensing electrode, the laser cut extending through and removing any electrode material and any sensing chemistry material in the pattern, and the laser cut forming a gap physically and electrically separating the electrode material and the sensing chemistry material inside the laser cut from the electrode material and the sensing chemistry material outside the laser cut.

A second embodiment comprises a method of the first embodiment in which the substrate has a second surface opposite the first surface, the method further comprising applying a counter and/or reference electrode onto the second surface. Alternately, the second side may not be used as a counter or counter reference electrode, but also as a second detection electrode, e.g., for another analyte, or not used at all.

A third embodiment comprises the first embodiment in which the counter and/or reference electrode is applied onto the first surface.

A fourth embodiment comprises the first embodiment further comprising applying a diffusion limiting membrane to fill the gap after forming the gap.

In a fifth embodiment, the method comprises the first embodiment in which applying the sensing chemistry material comprises applying a wet sensing chemistry material and then drying/curing it, the dried/cured sensing chemistry material having portions produced by an edge effect, and the laser cut being configured to physically and electrically separate the edge effect material from the sensing electrode.

A sixth embodiment comprises the first embodiment method in which the electrode material spans from a proximal electrode edge to a distal electrode edge, the laser cut forming a U-shaped gap comprising a first gap portion extending longitudinally of the sensing electrode edge, a second gap portion extending laterally of the sensing electrode, and a third gap portion extending longitudinally. Alternately, the laser cut may have many different shapes to accommodate a variety of sensing electrode configurations. A seventh embodiment comprises the sixth embodiment in which the first, second and third gap portions form a continuous gap.

An eighth embodiment is a method for producing an electrochemical analyte sensing electrode comprising a substrate having a first surface comprising a sensing chemistry on an electrode, the method comprising applying an area of electrode material onto the first surface of the substrate; applying a sensing chemistry material covering the area of the electrode material; and following the applying of the sensing chemistry, making a laser cut extending fully through the electrode material and the sensing chemistry material and not through the substrate, the laser cut configured to define the sensing electrode inside the laser cut, the laser cut forming a gap physically and electrically separating the electrode material and the sensing chemistry material inside the laser cut from the electrode material and the sensing chemistry material outside the laser cut, the laser cut thereby defining an active perimeter of the sensing electrode, the sensing electrode being isolated from electrode material and sensing chemistry material outside the active perimeter.

A ninth embodiment comprises the eighth embodiment in which the substrate has a second surface opposite the first surface, the method further comprising applying a counter and/or reference electrode onto the second surface.

In a tenth embodiment, the method comprises the eighth embodiment and further comprising applying a diffusion limiting membrane onto the sensing chemistry material and filling the gap. An eleventh embodiment comprises the eighth embodiment in which applying the sensing chemistry material comprises applying a wet sensing chemistry material and then drying/curing it, the dried/cured sensing chemistry material having portions produced by an edge effect, and the laser cut being configured to physically and electrically separate the edge effect material from the sensing electrode.

A twelfth embodiment comprises the eighth embodiment which the laser cut forms a U-shaped gap comprising a first gap portion extending longitudinally of the sensing electrode, a second gap portion extending laterally of the substrate, and a third gap portion extending longitudinally of the sensing electrode. A thirteenth embodiment comprises the twelfth embodiment in which the first, second and third gap portions form a continuous gap.

A fourteenth embodiment comprises a method for producing a plurality of electrochemical analyte sensing electrodes by separating the sensing electrodes from a continuous substrate, the method comprising applying onto a substrate a plurality of electrode systems, each electrode system comprising an area of electrode material on the substrate and an area of sensing chemistry material covering the area of electrode material; as to each electrode system, making a laser cut extending fully through the electrode material and the sensing chemistry material and not through the substrate, each laser cut being configured to define a sensing electrode inside the laser cut, each laser cut forming a gap physically and electrically separating the electrode material and the sensing chemistry material inside the laser cut from the electrode material and the sensing chemistry material outside the laser cut, each sensing electrode being isolated from electrode material and sensing chemistry material outside the gap; and following the making of the laser cuts, separating the sensing electrodes from the substrate.

In a fifteenth embodiment, the fourteenth embodiment further comprises making the laser cuts by moving the substrate relative to a laser beam, and directing the laser beam continuously over successive ones of the plurality of electrode systems. A sixteenth embodiment comprises the fourteenth embodiment in which each electrode system comprises a proximal electrode edge and a distal electrode edge, each laser cut forming a U-shaped gap comprising a first portion extending longitudinally of the sensing electrode, a second portion extending laterally of the sensing electrode, and a third portion extending longitudinally of the sensing electrode.

In a seventeenth embodiment, the fourteenth embodiment further comprises applying the plurality of electrode systems comprises applying the sensing chemistry material as a continuous stripe of sensing chemistry material over the plurality of electrode systems. An eighteenth embodiment comprises the seventeenth embodiment in which applying the plurality of electrode systems comprises applying the areas of electrode material as a continuous stripe of electrode material over the plurality of electrode systems.

The nineteenth embodiment comprises the eighteenth embodiment in which applying the plurality of electrode systems comprises applying the areas of sensing chemistry material as a continuous stripe of sensing chemistry material over the plurality of electrode systems. In the twentieth embodiment, the fourteenth embodiment further comprises, prior to separating the sensing electrodes, applying onto the substrate for each electrode system a second area of electrode material comprising a counter and/or reference electrode.

In the twenty-first embodiment, the fourteenth embodiment further comprises, as to each electrode system, making a laser cut comprising directing a laser beam toward the substrate to define the laser cut in a pattern configured to define at least a portion of the perimeter of the sensing electrode, the laser cut extending through and removing any electrode material and any sensing chemistry material in the pattern. The twenty-second embodiment comprises the twenty-first embodiment in which making each laser cut comprises moving the substrate relative to the laser beam using a reel-to-reel process.

The twenty-third embodiment comprises the fourteenth embodiment and further including, after making the laser cut and prior to separating the sensing electrodes, filling the gap. In the twenty-fourth embodiment, the twenty-third embodiment further includes the filling the gap comprises applying a diffusion limiting membrane onto the substrate covering the sensing chemistry and the filling the gap.

The twenty-fifth embodiment comprises an electrochemical analyte sensing electrode comprising: a substrate having a first surface; an area of electrode material on the first surface; and a sensing chemistry material covering the area of electrode material, the electrode material and the sensing chemistry material comprising a gap physically and electrically separating electrode material and sensing chemistry material inside the gap from electrode material and sensing chemistry material outside the gap, the electrode material and the sensing chemistry material inside the gap comprising the sensing electrode isolated from the electrode material and the sensing chemistry material outside the gap.

In the twenty-sixth embodiment, the twenty-fifth embodiment further comprises the sensing chemistry material covering the area of electrode material forms a layered area comprising both electrode material and overlying sensing chemical material, the gap extending fully within the layered area. The twenty-seventh embodiment comprises the twenty-sixth embodiment in which the gap has a width of 1 µm to 50 µm. In the twenty-eighth embodiment, the twenty-fifth embodiment comprises the electrode material spanning distally from a proximal electrode edge, the laser cut forming a U-shaped gap comprising: a first gap portion extending longitudinally of the sensing electrode, a second gap portion extending laterally of the sensing electrode, and a third gap portion extending longitudinally of the sensing electrode.

The twenty-ninth embodiment comprises the twenty-eighth embodiment in which the first, second and third gap portions form a continuous gap. In the thirtieth embodiment, the twenty-fifth embodiment comprises the substrate has a second surface opposite the first surface, and the sensing electrode further including a counter and/or reference electrode on the second surface.

In the thirty-first embodiment, the twenty-fifth embodiment further comprises a diffusion limiting membrane covering the sensing chemistry material and filling the gap.

An object of the invention is to reduce or eliminate edge effect areas which may present irregularities such as to shape and thickness.

Another object of the invention is to reduce the inactive surface area to improve interferants immunity of the sensor by reducing the electrochemical surface area, where the interferants may be unspecifically oxidized.

A further object of the present invention is to provide sensing electrodes having well defined actives areas.

A still further object is to provide methods for producing electrochemical biosensors, which methods are suitable for reel-to-reel and other continuous processes.

An additional object is to avoid the use of surface area ablation previously used to remove large portions of sensing chemistry. This achieves a technical advantage in terms of increased speed over the use of surface ablation, since there is no need to scan large areas.

### BRIEF DESCRIPTION OF THE DRAWINGS

FIG. 1 is a prior art schematic view showing the edge effect, such as occurs for a drying or curing solution, which can distort the profile of a sensing chemistry.

FIG. 2 is a prior art schematic view showing the reduced thickness of a diffusion limiting membrane where the electrode material and the sensing chemistry material extend all the way to the edge of the underlying substrate of a sensing electrode.

FIG. 3 is a prior art schematic view showing the step profile of electrode material following area ablation of the sensing chemistry of a sensing electrode, and the resultant thinning of the diffusion limiting membrane at the interior edge of the step.

FIG. 4 is a partial, schematic, cross-sectional view of the substrate, electrode material and sensing chemistry material of a sensing electrode in an embodiment. In particular, FIG. 4 shows the profile of a gap extending through the electrode material and the sensing chemistry material, thereby separating “active” and “non-active” electrode materials and sensing chemical materials.

FIG. 5 is a partial, schematic, cross-sectional view depicting the application of a diffusion limiting membrane over the sensing chemistry of the sensing electrode, and showing the filling of the gap to further isolate active materials from non-active materials.

FIG. 6 is a schematic view exemplifying the production of the disclosed sensing electrodes and biosensors in a continuous, e.g., reel-to-reel, process embodiment.

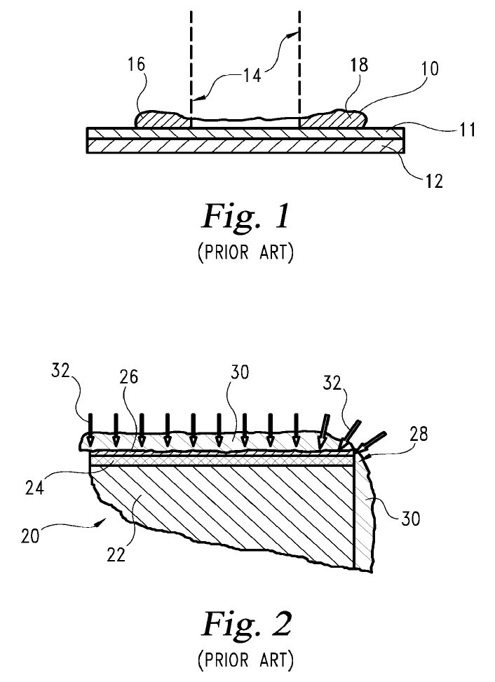

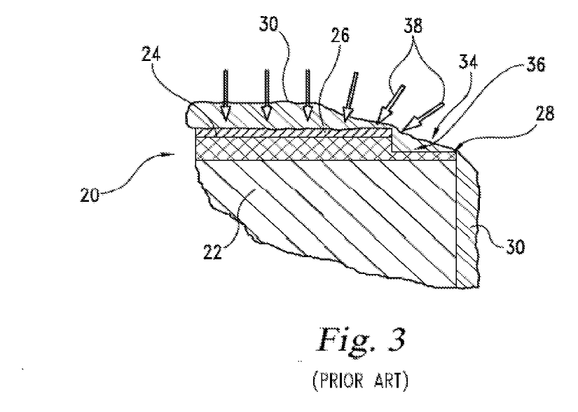

### DESCRIPTION

The methods described herein provide for the production various electrochemical analyte sensing electrodes and biosensors. The sensing electrodes and the biosensors of the present invention are useful for a wide variety of analytes detectable by electrochemical systems. In a particular aspect, the methods provide biosensors suitable for the detection of analytes in a body tissue or fluid. By way of example, but not to be limiting, the sensing electrodes have particular application for the detection of glucose levels in a bodily fluid.

In conventional fashion, the disclosed biosensor is configured to have one end received by a meter or similar monitoring device. The other end of the biosensor is configured to be dosed with the fluid specimen. The biosensor includes a sensing electrode operable to detect the analyte electrochemically. The sensing electrode is electrically connected to the meter, and a measured property is used in the determination of the analyte.

Any area of a sensing electrode which is electrically connected to the monitoring device may contribute to the electrochemical measurement. However, that can involve areas which, as previously described, can adversely distort the analyte measurements. The present disclosure therefore provides sensing electrodes which substantially limit, or exclude, participation of extraneous components in the electrochemical measurement. Participation is negated by physically and electrically isolating the sensing electrode from extraneous materials on the substrate. These materials may remain on the substrate, but the disconnection of the sensing electrode renders the materials non-active for purposes of the electrochemical measurements.

In a broad sense, the inventive methods comprise applying an area of sensing chemistry covering an area of electrode material. A laser cut is made through the electrode material and through the sensing chemistry material to define the perimeter of the active area of the sensing electrode. The separated regions comprising sensing chemistry are still chemically active, e.g., enzyme is still converting glucose. However, the laser gap separates these regions of the sensing chemistry from the sensing electrode.

The present method thus provides a gap which physically and electrically separates active and non-active electrode materials and sensing chemistry materials. Any electrode material and/or sensing chemistry material on the substrate which is outside of the gap is disconnected from the sensing electrode. The terms “extraneous” and/or “non-active” are used to refer to material that is present on the substrate, but that does not form a part of the sensing electrode. There is no, or essentially no, physical or electrical connection between the active areas of the sensing electrode and the non-active areas, due to the physical disconnection between these areas. That is, the extraneous materials are isolated from the active sensing electrode by the gap.

It is desirable to ensure that these extraneous materials do not contribute to the electrochemical measurements as that can distort the analyte determination. Since the sensing electrode is isolated from the non-active areas, the sensing electrode operates without undue influence from the extraneous materials. Without physical and/or electrical connections across the gap, the outside material cannot participate in the electrochemical determination.

### Laser Cut

The laser cut is configured to extend fully through the encountered sensing chemistry material and electrode material, all the way to the substrate. Thus, there is no physical or electrical connection between materials on the opposite sides of the gap. The cut forms a gap that is sufficient to isolate the sensing electrode from the extraneous portions of the electrode material and of the sensing chemistry material.

It is a feature of the present invention that the inventive sensing electrode is defined by a narrow gap extending through the electrode material and through the sensing chemistry material. The provision of the gap herein is distinguished from prior art approaches in which significant areas of sensing chemistry were surface ablated in an effort to totally remove extraneous sensing chemical material. The present invention instead physically and electrically isolates the sensing electrode from extraneous materials on the substrate, and there is no necessity for removing more of the electrode material or of the sensing chemistry material.

In a preferred embodiment, the laser cut is made by a narrow laser beam, and forms a narrow gap. It will be appreciated that the laser cut need only form a gap that is wide enough to assure that the active and non-active materials remain physically and electrically disconnected. As used herein, the term “narrow“ refers to a gap that at its lower limit has only as much of a width as is sufficient to provide this disconnection. A distinct advantage comes from using as narrow a gap as feasible as it may be readily formed while minimizing the time and expense otherwise involved with making a wider gap. It is within the skill in the art to determine an acceptable gap for a given electrode system comprising electrode material covered by sensing chemistry material.

In a preference, the gap has a width that is practical to produce, while being sufficiently wide to assure that the active area of the sensing electrode is isolated from the extraneous electrode material and sensing chemistry material on the outside of the gap, i.e., that the physical and electrical separation is assured. In embodiments, the gap may have a width between 1 µm and 50 µm, and more preferably a lesser width between 5 µm and 10 µm.

In embodiments, the laser cut comprises a linear laser cut which forms a linear gap. The term “linear” refers to a laser cut or gap which has a length substantially longer than its width. In an aspect, the linear laser cut is one in which the laser beam makes a single-width, continuous cut of the material. Thus, a linear laser cut comprises one that is formed by scribing a laser beam over a surface, thereby forming a gap with a width corresponding to the width of the laser beam. This facilitates the speed of producing the laser cut, and therefore the biosensor. The term “linear” is not used to suggest or require any particular shape of the cut, e.g., it need not be in a straight line. The shape of the laser cut will depend on the shape of the electrode.

The laser cut may be made in a variety of ways. For example, the cut may be made using various types of lasers. There may be a single pass or multiple passes of a laser in forming the gap, including having multiple lasers make increasingly deeper cuts in the sensing chemistry and electrode material. Also, the laser(s) may work in stop-and-go mode, where the substrate is moved and stopped for the duration of the laser treatment of the exposed area. The laser is then moved, while the substrate is not moving. Thus, the laser may be stationary while the material is moving, and the material is stationary and the laser is moving.

A linear gap is also one that retains approximately a same, narrow width throughout its length. In particular, the laser cutting is to be distinguished from broad field or surface laser ablation, such as used in the prior art to ablate relatively large areas of sensing chemistry in an effort to eliminate the impact of extraneous electrode material and sensing chemistry material on an electrode.

There is no limit as to the nature of the laser that is used provided it functions to make the laser cut as disclosed herein. The laser and its operating parameters are selected to cut fully through both the sensing chemistry material and the electrode material. The laser preferably does not cut into the substrate, although that is not a requirement. For example, a slight cutting into the substrate may be desirable to further ensure the physical and electrical disconnection of the materials on opposite sides of the gap. The selection of the type and the operating parameters of the laser to accomplish the described laser cutting is well within the skill in the art.

### Filling the Gap

The separation of the active materials of the sensing electrode from the non-active materials on the substrate is enhanced by filling the gap with a suitable material. Filling the gap occurs after the laser cutting is completed, and prior to separating the sensing electrodes. There is a wide selection of materials useful to fill the gap, and selection of the filling material is well within the ordinary skill in the art.

In one aspect, the gap is filled using a diffusion limiting membrane. A diffusion limiting membrane is frequently used with electrochemical biosensors, particularly with biosensors that are used in vivo. The diffusion limiting membrane regulates the absolute and relative diffusion of analyte and other species to the sensing chemistry. The diffusion limiting membrane is applied, inter alia, in areas where uncontrolled diffusion to the sensing chemistry may present an issue.

Relative to filling the gap, the diffusion limiting membrane may be applied to the sensing electrode in any manner suitable for having the diffusion limiting membrane fill the gap

### Method of Producing

In one aspect, the present invention provides methods for producing a sensing electrode. The methods comprise applying an area of an electrode material onto a substrate. A sensing chemistry material is then applied covering the area of electrode material, thereby forming a “layered area” comprising both electrode material and sensing chemistry material. The layered area of electrode material and sensing chemistry material is preferably used to form the sensing electrode.

Following the applying of the sensing chemistry, a laser beam is directed toward the layered area to form a laser cut in the electrode and sensing chemistry materials in a pattern configured to define at least a portion of the perimeter of the sensing electrode. The laser is operated to cut through any electrode material and any sensing chemistry material at which it is directed. The laser cut extends through the materials down to the substrate, but preferably not into the substrate.

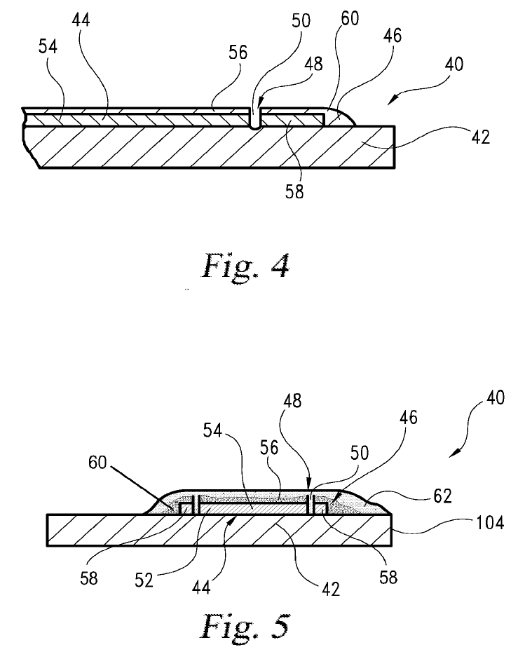

With reference to FIG. 4, in an embodiment, the sensing electrode 40 comprises a substrate 42 covered with an electrode material 44. Sensing chemistry material 46 is applied over electrode material 44, for example as a line of material configured to extend across the sensing electrode from side to side. Sensing electrode 40 is prepared by first applying the electrode material 44 to the substrate 42, and then overlaying the electrode material 44 with the sensing chemistry material 46. Following application of sensing chemistry material 46, a laser cut 48 is made which extends through both sensing chemistry material 46 and electrode material 44, but not significantly into the substrate 42.

The result of making the above-described laser cut is a gap 50. The function of gap 50 is to physically and electrically isolate non-active electrode material and non-active sensing chemistry material that is located outside of gap 50 from active electrode material and the active sensing chemistry material that is located inside of the gap. An electrode 52 (see FIG. 5) is thereby defined by the laser cut forming gap 50, and the perimeter of electrode 52 is provided with precisely located and well refined, laser-cut edges.

The result of the laser cut is shown in profile in FIG. 4. Substrate 42 is coated with electrode material 44. Sensing chemistry material 46 is coated over electrode material 44. The laser cut 48 is positioned to cut though both the sensing chemistry material and the electrode material all the way down to, but preferably not significantly into, substrate 42. As shown, the laser cut thereby separates material that is inside the cut, from material that is outside the cut. The inside electrode material 54 constitutes the active part of the electrode 52, and the inside sensing chemistry material 56 constitutes the active sensing chemistry associated with electrode 52. These materials are isolated from the outside electrode material 58 and the outside sensing chemistry 60.

Referring to FIG. 5, a diffusion limiting membrane 62 is shown applied over the sensing electrode 40. In an embodiment, a diffusion limiting membrane is applied by dip coating and for biocompatibility covers the complete portion of the sensor inserted into a person’s body. Diffusion limiting membrane 62 typically covers any or all portions of the sensing electrode, particularly the active sensing chemical material 56. In an embodiment, the laser cut is formed before the diffusion limiting membrane or other such layers are added.

In one embodiment, the diffusion limiting membrane is applied, such as by slot-die coating on the not yet separated sensors. After that, the sensors can be separated by laser and then the separated sensors can be, preferably, dip coated by another diffusion limiting layer and/or by one or more biocompatibility polymer layers. In an embodiment, the diffusion limiting membrane is simultaneously a biocompatibility membrane. If the membrane is only applied after sensor separation, then the gap formation and sensor separation may be done within one manufacturing step, as both steps can be done with a laser.

Diffusion limiting membrane 62, when used, isapplied such that it covers, and fills gap 50. In typical embodiments, the gap is sufficiently narrow that it is completely filled by the diffusion limiting membrane during the coating of the membrane, and thus the morphology of the resulting membrane coating is very homogenous, which again positively effects the sensor performance.

### Continuous Web Production

The present invention also provides an expeditious method for producing a plurality of electrochemical analyte sensing electrodes and biosensors by separating them from a continuous substrate. A feature of the present invention is that it greatly simplifies and speeds up the commercial production of biosensors.

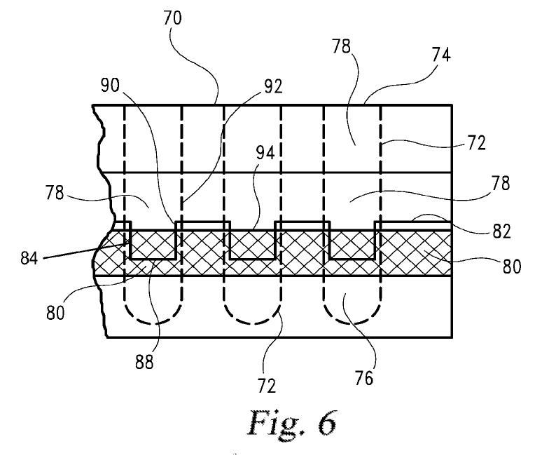

Referring to FIG. 6, there is shown a diagrammatic representation of the production of biosensors from a continuous substrate 70. Substrate 70 is used to produce biosensors shown by dashed lines 72. The biosensors, once separated, extend from a mechanical end 74 to a biological end 76. The method comprises applying a plurality of electrode systems onto substrate 70. Each electrode system comprises an area of electrode material 78 located on the substrate, and an area of sensing chemistry material 80 covering an area of electrode material. A laser beam is directed at the substrate 70 along a line 82. The laser cut is shown being made through appropriate areas of sensing chemistry material 80 and electrode material 78 in a manner as previously discussed.

As shown, both the electrode material 78 and the sensing chemistry material 80 of the electrode systems are continuous stripes of material. However, either or both may be applied as discrete areas of material corresponding to the electrode systems. The materials are applied in any suitable manner. In an embodiment, for example, the sensing chemistry is applied by slot die coating. Both the electrode material and the sensing chemistry material are applied at least at a slightly greater surface area than the final active area of the sensing electrode. Extraneous portions are then isolated from the sensing electrodes by the laser cuts. Areas such as those comprising inhomogeneities or non-uniformities are then isolated.

For each electrode system, a laser cut is made, as previously described, extending fully through the electrode material 78 and the sensing chemistry material 80, but not cutting significantly into the substrate 70. Each laser cut is configured to define a sensing electrode inside the laser cut, as each laser cut forms a gap physically and electrically separating the electrode material and the sensing chemistry material inside the laser cut from the electrode material and the sensing chemistry material outside the laser cut. Each laser cut defines an active perimeter of a sensing electrode. The sensing electrode is thereby isolated from electrode material and sensing chemistry material outside the active perimeter.

The laser cut may be made by moving the substrate and the laser beam relative to one another. Preferably, the laser beam continuously impinges on the continuous web of electrode systems. Following the making of the laser cut, the sensing electrodes are separated from the substrate.

In an embodiment, each electrode system comprises electrode material 78 defining a mechanical electrode end 74 and a biological electrode end 76. In an embodiment, the laser cuts form a U-shaped gap comprising a first gap portion 84 extending longitudinally of the sensing electrode configured to be close to a side of a separated sensing electrode, as shown by first dashed line 86. The cut then includes a second gap portion 88 extending laterally of the sensing electrode. A third gap portion 90 is formed extending longitudinally of the sensing electrode configured to be at the opposite side of the separated sensing electrode, as shown by third dashed line 92. The gap is thus shown to be a continuous gap extending into and out of the sensing chemistry material. The resulting U-shaped gap encompasses a substantial portion of the electrode material covered by sensing chemistry material.

In one aspect, priorto separating the electrode systems, a second area of electrode material comprising a counter and/or reference electrode may be applied to the substrate. In an embodiment, the counter and/or reference electrodes are applied to the side of the substrate opposite the sensing electrodes. This facilitates making the subsequent laser cuts into the areas of electrode materials and sensing chemistry materials. In an alternate embodiment, the counter and/or reference electrode may be positioned on the same side of the substrate as the working electrode. Additionally, in embodiments, multiple working electrode systems can be place on one or both sides of the substrate, and the linear laser ablation can be used with some or all of them.

It will further be appreciated that the order of steps in the process can be varied. For example, the timing of applying the working electrode material may precede or follow the formation of any counter and/or reference electrode. The timing of the separation of the individual test strips may occur before or after the application of materials, such as the diffusion limiting membrane.

The sensing chemistry is axially isolated from the conductive substrate. In this way, the upper edge 94 of the sensing chemistry material 80 is already well defined and does not suffer from the edge effect. The edge 94 of the electrode material cooperates with the gap to complete the active perimeter of the sensing electrode, and to isolate the sensing electrode. The remaining three edges are then defined by the linear ablation. The huge advantage here is drastic reduction of the conductive surface area, which is not modified by the sensing chemistry, thus improving the sensor performance towards immunity to interferants, as the surface area, where the interferants may be unspecifically oxidized is lower.

FIG. 6 thus depicts the making of a laser cut in a continuous web carrying a series of electrode systems. In this embodiment, the laser is preferably operated to continuously move relative to the web, thereby using the laser beam to scribe the laser cut 82 into the electrode material and into the sensing chemistry material. Since the laser is configured so as not to cut into the substrate, where there is no electrode material or sensing chemistry material, there is no gap produced. Therefore, FIG. 6 shows an embodiment in which the laser beam operates continuously, and the gap extends between end points along the edge of the sensing chemistry.

The embodiment of FIG. 6 shows the use of the present method in the formation of a substantial portion of the sensing electrode perimeter. It will be appreciated that the concept of the laser cut through both the electrode material and the sensing chemistry material can be used to define as much of the sensing electrode perimeter as desired. In the extreme, the laser cut could scribe a line fully surrounding the sensing electrodes. In the alternative, the concept could be used to isolate only selected portions of the sensing electrode perimeter.

The laser cut need not be continuous, depending on the materials located along the line of cutting. For example, if the laser cuts along a line where there is no sensing chemistry material and no electrode material, then therewould be nothing for the laser to cut. In this respect, the laser can be programmed to dynamically tune its power during its movement, so it will reduce the power or switch the beam completely off, if it moves above those areas, which shall not be somehow cut or ablated.

Also, the laser may cut along a line where there is only electrode material or only sensing chemistry material. In any case, the laser forms a gap in the material that is present. In the case of only electrode material being present, the isolating of the extraneous electrode material outside the cut line will prevent the introduction of error based upon interferents contributing to the measured signal. Where only sensing chemistry material is present, the isolating of the extraneous sensing chemistry material outside the cut will prevent analyte and other materials from diffusing to the sensing electrode.

The gap is provided in a configuration that precludes connection of active materials with non-active materials. To do so, the gap extends between points such that there is no opportunity for there to be a physical or electrical connection by “going around” the gap. For this to be accomplished, the gap extends between end points such that the extraneous materials are isolated from the sensing electrode. This may be accomplished, for example, by having the end point be at the side edges of the substrate or at the edges of the electrode material.

In embodiments, the gap extends from an end point on one side of the substrate to an end point on the second side of the substrate. The end points also may both be at the proximal edge of the electrode material, or one endpoint may be at one of the substrate sides and the other endpoint may be at the electrode edge. As previously noted, the edge of the electrode material itself acts as a part of the active perimeter of the sensing electrode.

It will be further appreciated that the advantages of the present invention can at least partially be achieved without fully isolating the sensing electrode. For example, the gap could be configured so as to isolate less than all of the extraneous material. In some configurations of the electrode, it may be that small portions of the applied electrode material and/or sensing chemistry material are difficult to readily include within the area defined by a gap.

For example, it may be sufficient to only isolate the material along the sides of an electrode, which would substantially diminish the measurement distortions that would otherwise occur. This could be accomplished, for example, by simply forming gaps extending along both side edges of the substrate, from the proximal electrode edge to the distal electrode edge. The impact of extraneous materials on the operation of the sensing electrode would still be substantially reduced.

### Sensing Electrode Components

### Substrate

The present invention has broad application to the production of sensing electrodes and biosensors. The concept applies specifically to the manner of forming the active area of a sensing electrode. Various substrates are well known in the art as being suitable for the production and use of biosensors, including for example in vivo biosensors. The selection of a substrate for the disclosed biosensors and methods is well within the ordinary skill in the art, and the invention is not limited to particular substrates.

In a preferred embodiment, the substrate is a continuous material and a plurality of biosensors are obtained by separation of the biosensors from the continuous substrate. The term “separation” is known in the art to refer to processes in which individual biosensors are derived from a continuous web of substrate material. Various methods for separating biosensors are known in the art, and the present disclosure is not limited as to the manner of separation.

### Sensing Chemistry

The sensing chemistry may be any chemistry suitable for the electrochemical determination of an analyte. The invention is independent of the selection of the sensing chemistry material, and of its manner of application to the sensing electrode.

### Electrode

The present disclosure is directed to sensing electrodes which detect an analyte by measuring a property of an electrochemical reaction involving the analyte. As used herein, the term “electrode” refers to a conductive component configured to be useful for the electrochemical detection of an analyte.

The present invention is applicable for a variety of electrode configurations. For convenience, there is shown a common electrode design in that the sensing electrode is a biosensor comprising a rectangular shape. However, the disclosed method is advantageously used for any of a wide variety of electrode configurations known in the art. The electrode material may consist of any materials suitable for use as electrodes in an electrochemical system. For example, but without limiting the invention, the electrode material is exemplified as a conductive carbon material. The electrode materials may be applied to the substrate in any manner operable to provide the electrodes. The selection of electrode materials and configurations for the disclosed method is well within the ordinary skill in the art, and the invention therefore is not limited to particular electrode systems.

### Sensing Electrode

The term “sensing electrode” refers to an electrode which has an overlying layer of a sensing chemistry such that the combination of the sensing chemistry and the electrode is configured to conduct electrochemical testing for an analyte. In particular embodiments, the sensing electrode is configured for detecting an analyte in a body tissue or fluid.

The sensing electrode can be combined with a counter and/or reference electrode provided on the same substrate. In an embodiment, the counter and/or reference electrode is provided on the same side of the substrate as the sensing electrode. However, the counter and/or reference electrode may instead be located on the opposite side of the substrate. Locating the counter and/or reference electrode on the opposite side can be advantageous in that it facilitates using the laser to cut the side with the sensing electrode.

### Conclusion

The prior art has addressed non-uniformity of electrodes, sensing chemistries, and diffusion limiting membranes by ablating total areas of the sensing chemistry. The present method instead prepares narrow gaps which eliminate the problems of non-uniformity of sensing chemistries outside the sensing electrode, effectively disconnecting them from contributing to the electrochemical measurement. The analyte and possible interferents do not traverse this gap. This can be further assured by filling of the gap, such as with portions of a diffusion limiting membrane, or another later-applied material. Furthermore, sensing chemistry suffering from edge effects is separated as well, which enhances sensor performance. Furthermore, a significant portion of electrode material is also separated, which enhances the active/inactive area ratio.

### CLAIM TERMS

10 sensing chemistry

11 electrode material

12 substrate

14 interior section

16 sensing chemistry portion

18 sensing chemistry portion

20 sensing electrode

22 substrate

24 carbon undercoat

26 sensing chemistry

28 edge

30 diffusion limiting membrane

32 arrows

34 outer portion of 26

36 step profile

38 arrows

40 sensing electrode

42 substrate

44 electrode material

46 sensing chemistry material

48 laser cut

50 gap (formed by laser cut)

52 electrode

54 inside electrode material

56 inside sensing chemistry material

58 outside electrode material

60 outside sensing chemistry material

62 diffusion limiting membrane

70 continuous substrate

72 dashed lines

74 mechanical biosensor end

76 biological biosensor end

78 electrode material

80 sensing chemistry material

82 laser cut

84 first gap portion

86 first dashed line

88 second gap portion

90 third gap portion

92 dashed line

94 edge

1. A method for producing a sensing electrode comprising:
applying an area of electrode material onto a first surface of a substrate;
applying a sensing chemistry material covering the area of electrode material; and
following the applying of the sensing chemistry material, directing a laser beam toward the substrate to form a laser cut in a pattern configured to define at least a portion of the perimeter of the sensing electrode,
the laser cut extending through and removing any electrode material and any sensing chemistry material in the pattern, and
the laser cut forming a gap physically and electrically separating the electrode material and the sensing chemistry material inside the laser cut from the electrode material and the sensing chemistry material outside the laser cut.

2. The method of claim 1 in which the substrate has a second surface opposite the first surface, the method further comprising applying a counter and/or reference electrode onto
the second surface.

3. The method of claim 1 further comprising applying a diffusion limiting membrane to fill the gap after forming the gap.

4. The method of claim 1 in which applying the sensing chemistry material comprises applying a wet sensing chemistry material and then drying/curing it, the dried/cured sensing chemistry material having portions produced by an edge effect, and the laser cut being configured to physically and electrically separate the edge effect material from the sensing electrode.

5. The method of claim 1 in which the electrode material spans from a proximal electrode edge to a distal electrode edge, the laser cut forming a U-shaped gap comprising:
a first gap portion extending longitudinally of the sensing electrode edge,
a second gap portion extending laterally of the sensing electrode, and
a third gap portion extending longitudinally.

6. The method of claim 5 in which the first, second and third gap portions form a continuous gap.

7. A method for producing an electrochemical analyte sensing electrode comprising a substrate having a first surface comprising a sensing chemistry on an electrode, the method comprising:
applying an area of electrode material onto the first surface of the substrate;
applying a sensing chemistry material covering the area of the electrode material; and
following the applying of the sensing chemistry, making a laser cut extending fully through the electrode material and the sensing chemistry material and not through the substrate,
the laser cut configured to define the sensing electrode inside the laser cut,
the laser cut forming a gap physically and electrically separating the electrode material and the sensing chemistry material inside the laser cut from the electrode material and the sensing chemistry material outside the laser cut,
the laser cut thereby defining an active perimeter of the sensing electrode, the sensing electrode being isolated from electrode material and sensing chemistry material outside the active perimeter.

8. The method of claim 7 in which the substrate has a second surface opposite the first surface, the method further comprising applying a counter and/or reference electrode onto
the second surface.

9. The method of claim 7 and further comprising applying a diffusion limiting membrane onto the sensing chemistry material and filling the gap.

10. The method of claim 7 in which applying the sensing chemistry material comprises applying a wet sensing chemistry material and then drying/curing it, the dried/cured sensing chemistry material having portions produced by an edge effect, and the laser cut being configured to physically and electrically separate the edge effect material from the sensing electrode.

11. The method of claim 7 in which the laser cut forms a U-shaped gap comprising:
a first gap portion extending longitudinally of the sensing electrode,
a second gap portion extending laterally of the substrate, and
a third gap portion extending longitudinally of the sensing electrode.

12. The method of claim 11 in which the first, second and third gap portions form a continuous gap.

13. A method for producing a plurality of electrochemical analyte sensing electrodes by separating the sensing electrodes from a continuous substrate, the method comprising:
applying onto a substrate a plurality of electrode systems, each electrode system comprising an area of electrode material on the substrate and an area of sensing chemistry material covering the area of electrode material;
as to each electrode system, making a laser cut extending fully through the electrode material and the sensing chemistry material and not through the substrate,
each laser cut being configured to define a sensing electrode inside the laser cut,
each laser cut forming a gap physically and electrically separating the electrode material and the sensing chemistry material inside the laser cut from the electrode material and the sensing chemistry material outside the laser cut,
each sensing electrode being isolated from electrode material and sensing chemistry material outside the gap; and
following the making of the laser cuts, separating the sensing electrodes from the substrate.

14. The method of claim 13 in which making the laser cuts comprises moving the substrate relative to a laser beam, and directing the laser beam continuously over successive ones of the plurality of electrode systems.

15. The method of claim 13 in which each electrode system comprises a proximal electrode edge and a distal electrode edge, each laser cut forming a U-shaped gap comprising:
a first portion extending longitudinally of the sensing electrode,
a second portion extending laterally of the sensing electrode, and
a third portion extending longitudinally of the sensing electrode.

16. The method of claim 13 in which applying the plurality of electrode systems comprises applying the sensing chemistry material as a continuous stripe of sensing chemistry material over the plurality of electrode systems.

17. The method of claim 13 in which applying the plurality of electrode systems comprises applying the areas of electrode material as a continuous stripe of electrode material over the plurality of electrode systems.

18. The method of claim 17 in which applying the plurality of electrode systems comprises applying the areas of sensing chemistry material as a continuous stripe of sensing chemistry material over the plurality of electrode systems.

19. The method of claim 13 and further comprising, prior to separating the electrode systems, applying onto the substrate for each electrode system a second area of electrode material comprising a counter and/or reference electrode.

20. The method of claim 13 in which, as to each electrode system, the making a laser cut comprises:
directing a laser beam toward the substrate to define the laser cut in a pattern configured to define at least a portion of the perimeter of the sensing electrode,
the laser cut extending through and removing any electrode material and any sensing chemistry material in the pattern.

21. The method of claim 20 in which making each laser cut comprises moving the substrate relative to the laser beam using a reel-to-reel process.

22. The method of claim 13 and further including, after making the laser cut and prior to separating the electrode systems, filling the gap.

23. The method of claim 22 in which filling the gap comprises applying a diffusion limiting membrane onto the substrate covering the sensing chemistry and the filling the gap.

24. An electrochemical analyte sensing electrode comprising:
a substrate having a first surface;
an area of electrode material on the first surface; and
a sensing chemistry material covering the area of electrode material,
the electrode material and the sensing chemistry material comprising a gap physically and electrically separating electrode material and sensing chemistry material inside the gap from electrode material and sensing chemistry material outside the gap,
the electrode material and the sensing chemistry material inside the gap comprising the sensing electrode isolated from the electrode material and the sensing chemistry material outside the gap.

25. The sensing electrode of claim 24 in which the sensing chemistry material covering the area of electrode material forms a layered area comprising both electrode material and overlying sensing chemical material, the gap extending fully within the layered area.

26. The sensing electrode of claim 25 in which the gap has a width of 1 µm to 50 µm.

27. The sensing electrode of claim 24 in which the electrode material spans distally from a proximal electrode edge, the laser cut forming a U-shaped gap comprising:
a first gap portion extending longitudinally of the sensing electrode,
a second gap portion extending laterally of the sensing electrode, and
a third gap portion extending longitudinally of the sensing electrode.

28. The sensing electrode of claim 27 in which the first, second and third gap portions form a continuous gap.

29. The sensing electrode of claim 24 in which the substrate has a second surface opposite the first surface, the sensing electrode further including a counter and/or reference electrode on the second surface.

30. The sensing electrode of claim 24 and further comprising a diffusion limiting membrane covering the sensing chemistry material and filling the gap.
